(19) United States
(12) Patent Application Publication
(10) Pub. No.: US 2006/0069851 A1
(43) Pub. Date: Mar. 30, 2006

(54) Integrated circuit memory devices that support detection of write errors occuring during power failures and methods of operating same

(76) Inventors: Hyun-Mo Chung, Seoul (KR); Chan-Ik Park, Seoul (KR)

Correspondence Address: MYERS BIGEL SIBLEY & SAJOVEC, PO BOX 37428, RALEIGH, NC, 27627, US

(21) Appl. No.: 11/020,705

(22) Filed: Dec. 22, 2004

(30) Foreign Application Priority Data
Sep. 30, 2004 (KR) 2004-77924

(51) Int. Cl. G06F 13/00

(52) U.S. Cl. 711/103; 711/154

(57) ABSTRACT

Integrated circuit devices that support error detection include a non-volatile memory device having a memory array therein containing a plurality of pages of memory cells. A memory controller is also provided. The memory controller is electrically coupled to the non-volatile memory device and is configured to provide the non-volatile memory device with a plurality of segments of page data during a page write operation. The plurality of segments of page data include a plurality of segments of checksum data that identify a number of non-volatile memory cells to be programmed with write data during the page write operation. Additional checksum data is also generated for comparison and error detection purposes during a page read operation.

### REFERENCE TO PRIORITY APPLICATION

This application claims priority to Korean Application Serial No. 2004-77924, filed Sep. 30, 2004, the disclosure of which is hereby incorporated herein by reference.

### FIELD OF THE INVENTION

The present invention relates to integrated circuit devices and methods of operating same and, more particularly, to integrated circuit memory devices and methods of operating same.

### BACKGROUND OF THE INVENTION

Error detection and correction (EDC) operations within integrated circuit devices make it possible to detect and possibly correct corrupted data transmitted across data links (e.g., buses) and stored in memory elements, for example. These EDC operations may use conventional error detection and correction algorithms, including read-Solomon codes (RC codes), Hamming codes, Bose-Chaudhuri-Hocquengem codes (BCH codes) and cyclic redundancy checking (CRC) codes, to detect and possibly correct a limited number of errors (e.g., soft errors). To support EDC operations within non-volatile memory devices, write data (to be checked and corrected, if necessary) is frequently stored with corresponding check bits (e.g., ECC check bits) that enable EDC operations to be performed on the write data. One typical EDC operation performed in flash memory devices is disclosed in U.S. Pat. No. 6,651,212 to Katayama et al.

Unfortunately, many of these conventional algorithms only have the capability of detecting relatively few errors (e.g., 1-2 bits) and possibly correcting even fewer detected errors (e.g., 1 bit correction). Accordingly, many of these conventional algorithms are not suitable for environments where large numbers of errors may occur during data transmission or storage. One memory technology that is vulnerable to large numbers of errors is non-volatile memory technology. For example, a low power non-volatile memory technology such as flash memory (e.g., NAND or NOR) may be vulnerable to the occurrence of power failures when large quantities of data are being written to a page of non-volatile memory cells (e.g., 4K non-volatile memory cells). Accordingly, after power has been restored, it may be necessary to identify the presence of errors in page data using EDC techniques that are computationally inexpensive and do not break down when more than a limited number of errors have occurred.

### SUMMARY OF THE INVENTION

Integrated circuit devices that support error detection operations according to embodiments of the present invention include a non-volatile memory device having a memory array therein containing a plurality of pages of non-volatile memory cells. This memory device may be a flash memory device, however, other types of memory devices may also be used. These other types of memory devices include MROM devices, PROM devices, FRAM devices and other related devices. A memory controller is also provided in these embodiments. In particular, the memory controller is electrically coupled to the non-volatile memory device and is configured to provide the non-volatile memory device with a plurality of segments of page data during a page write operation. The plurality of segments of page data include a plurality of segments of write data and a plurality of segments of checksum data that identify a number of non-volatile memory cells to be programmed with write data during the page write operation. Additional checksum data is also generated for comparison and error detection purposes during a page read operation.

According to additional embodiments of the invention, an integrated circuit device may include a memory device having a memory array therein containing a plurality of pages of memory cells and an input/output control circuit. The input/output control circuit is electrically coupled to the memory device. The input/output control circuit is configured to support a page write operation by sequentially writing a plurality of segments (e.g, 8-bit segments) of page data to the memory device in response to a write instruction. The plurality of segments includes at least one segment of data that identifies a number of the memory cells to be programmed with write data during the page write operation. The input/output control circuit is further configured to support a page read operation by comparing the at least one segment of data against additional data that identifies a number of memory cells actually programmed with write data during the page write operation. The number of memory cells actually programmed with write data may differ from the number of memory cells intended to be programmed with write data whenever a power failure event occurs. In some cases, the at least one segment of data may constitute first checksum data and the additional data may constitute second checksum data. This checksum data may be generated by a checksum generator within the input/output control circuit.

In further embodiments of the invention, the input/output control circuit may include a data path selection circuit disposed within a read/write data path of the integrated circuit device, with the checksum generator being coupled to the read/write path. The data path selection circuit includes a first switch responsive to an active flag signal. This active flag signal enables checksum data to be passed to the memory device during page write operations. A second switch may also be provided to route checksum data from the checksum generator to the first switch in response to the active flag signal. The memory device and the input/output control circuit may be disposed on a common semiconductor substrate or on separate integrated circuit substrates.

Still further embodiments of the invention include an integrated circuit device having a non-volatile memory device and memory controller therein. The non-volatile memory device has a memory array therein containing a plurality of pages of non-volatile memory cells. Each of these memory cells may support one or more bits of data (e.g., 2-bits representing four possible binary values 00, 01, 10 and 11). The memory controller is electrically coupled to the non-volatile memory device. The memory controller is configured to provide the non-volatile memory device with a plurality of segments of page data during a page write operation. These plurality of segments include a plurality of segments of checksum data that collectively identify a number of non-volatile memory cells to be programmed with write data during the page write operation. In still further embodiments of the invention, the memory controller may even include a supplemental memory array (e.g., “checksum data” memory array) configured to store a copy of the plurality of segments of checksum data transferred to the non-volatile memory device during the page write operation.

The memory controller is also configured to support a page read operation. This page read operation may include comparing the plurality of segments of checksum data received from the non-volatile memory device during the page read operation against additional checksum data that identifies a number of memory cells in the memory array actually programmed with write data during the page write operation. The number of memory cell actually programmed with write data may be less than the number of memory cells to be programmed with write data in the event a power failure occurs during the page write operation. The plurality of segments of checksum data that are generated during the page write operation and the additional checksum data generated during the page read operation may be generated by a checksum data generator.

Still further embodiments of the invention include methods of operating an integrated circuit memory device by generating first checksum data from first data received by the memory device and then writing the first data and the first checksum data into a non-volatile memory array within the memory device. The first data and the first checksum data are then read from the non-volatile memory array. To support error detection, second checksum data is generated from the first data read from the non-volatile memory array. This second checksum data is compared against the first checksum data read from the non-volatile memory array to detect differences therebetween. The presence of differences can signify the occurrence of a power failure during the operation to write the first data and the first checksum data into the non-volatile memory array.

According to these method embodiments, the step of generating first checksum data may include generating a plurality of segments of checksum data from a plurality of segments of the first data and the writing step may include writing the plurality of segments of the first data and the plurality of segments of checksum data in sequence across a data bus. This step of generating first checksum data may include generating intermediate checksum data values using an adder and accumulation register as the plurality of segments of the first data are processed in the memory device.

Still further embodiments of the invention include methods of operating an integrated circuit memory device by generating first checksum data from first data received by the memory device and then writing the first data and the first checksum data into a non-volatile memory array within the memory device using a page write operation. To support error detection operations, a copy of the first checksum data is also written into a supplemental “checksum” memory array within the memory device. Thereafter, during a page read operation, the first data and the first checksum data are read from the non-volatile memory array and a comparison is performed between the copy of the first checksum data read from the supplemental memory array and the first checksum data read from the non-volatile memory array. If this comparison results in a detection of an inequality, then a conclusion may be made that one or more errors are present in the first data.

### BRIEF DESCRIPTION OF THE DRAWINGS

FIG. 1 is a block diagram of an integrated circuit memory device according to embodiments of the present invention.

FIG. 2 is a detailed block diagram of the power failure judging circuit and the data path selection circuit illustrated by FIG. 1.

FIG. 3 is a block diagram of the checksum data generator illustrated by FIG. 2.

FIG. 4A is a diagram that illustrates operations for generating checksum data that may be performed by the checksum data generator of FIG. 3.

FIG. 4B is a diagram that illustrates how an occurrence of a power failure causes data errors when writing operations are being performed in the memory device of FIG. 1.

FIG. 4C is a diagram that illustrates additional operations for generating checksum data that may be performed by the checksum data generator of FIG. 3.

FIG. 5 is a flow diagram of writing and reading operations that may be performed by the memory device of FIG. 1.

FIG. 6A is a diagram that illustrates timing of write operations within the memory device of FIG. 1.

FIG. 6B is a diagram that illustrates timing of read operations within the memory device of FIG. 1.

FIG. 7 is a block diagram of a multi-chip integrated circuit memory device according to additional embodiments of the present invention.

FIG. 8 is a block diagram of a multi-chip integrated circuit memory device according to additional embodiments of the present invention.

### DESCRIPTION OF PREFERRED EMBODIMENTS

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout. Signals may also be synchronized and/or undergo minor boolean operations (e.g., inversion) without being considered different signals. The suffix B (or prefix symbol “/”) to a signal name may also denote a complementary data or information signal or an active low control signal, for example.

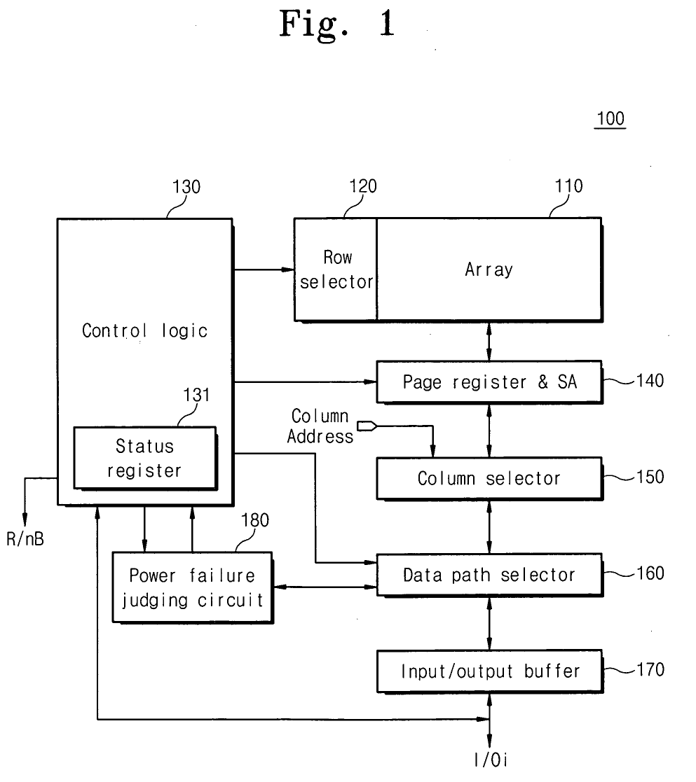

Referring now to FIG. 1, an integrated circuit memory device 100 according to embodiments of the invention will be described. This memory device 100 is treated herein as a non-volatile memory device, such as a NAND-type flash memory device. However, other types of memory devices may represent alternative embodiments of the invention. Some of these memory devices include MROM devices, PROM devices, FRAM devices and NOR-type flash memory devices. The memory device 100 is illustrated as including a memory array 110, which may be arranged as a plurality of rows and columns of non-volatile memory cells. Each row of the memory array 110 may be treated as containing a “page” of memory cells and a typical page width may be as large as 4K bits (e.g., 4096 memory cells) or larger, for example. As described herein, each row of the memory array 110 will be treated as having a page width of 528 bytes, which includes 526 main data bytes and 2 spare data bytes, with each byte containing 8 bits of data. Memory arrays having different page widths may also be utilized within embodiments of the invention. Moreover, the allocation of main data bytes and spare data bytes within a page may vary based on application. For example, a greater number of spare data bytes may be required in the event error detection and correction (EDC) bits (or other diagnostic bits) are to be stored within each page of data.

During a write or read operation, a row of memory cells within the memory array 110 may be selected by a row selector 120 (a/k/a row decoder), which is responsive to a row address generated by control logic 130. The memory array 110 is electrically coupled (e.g., by bit lines) to a page register and sense amplifier circuit 140, which is responsive to control signals generated by the control logic 130. This page register and sense amplifier circuit 140 may have a width equivalent to the page width of the memory array 110. During write operations (e.g., programming operations), the page register and sense amplifier circuit 140 drives columns within the memory array 110 with incoming data. During read operations, the page register and sense amplifier circuit 140 detects and amplifies data received from columns within the memory array 110.

The page register and sense amplifier circuit 140 is electrically coupled to a column selection circuit 150, which is responsive to a column address. This column selection circuit 150 is electrically coupled to a data path selection circuit 160. During write operations, the column selection circuit 150 operates to route write data from the data path selection circuit 160 to segments within the page register and sense amplifier circuit 140. During read operations, the column selection circuit 150 operates to route read data from segments within the page register and sense amplifier circuit 140 to the data path selection circuit 160. In the event the column selection circuit 150 is configured to route 8 bits (e.g., one byte) to the page register and sense amplifier circuit 140 during a single clock cycle and the page register and sense amplifier circuit 140 supports 4224 bits of data (4224=526×8 main bits+2×8 spare bits), then the column address may sequence through 528 consecutive addresses during a page write operation that spans 528 consecutive clock cycles.

The data path selection circuit 160 is electrically coupled to the column selection circuit 150, an input/output buffer 170 and a power failure judging circuit 180. The data path selection circuit 160, which is located within a read/write data path of the memory device 100, is also responsive to control signals generated by the control logic 130. In some embodiments, the memory array 110, the page register and sense amplifier circuit 140 and the column selection circuit 150 may be disposed on a first semiconductor substrate (along with an appropriate input/output buffer) and the data path selection circuit 160, power failure judging circuit 180, control logic 130 and input/output buffer 170 may be disposed on a second semiconductor substrate.

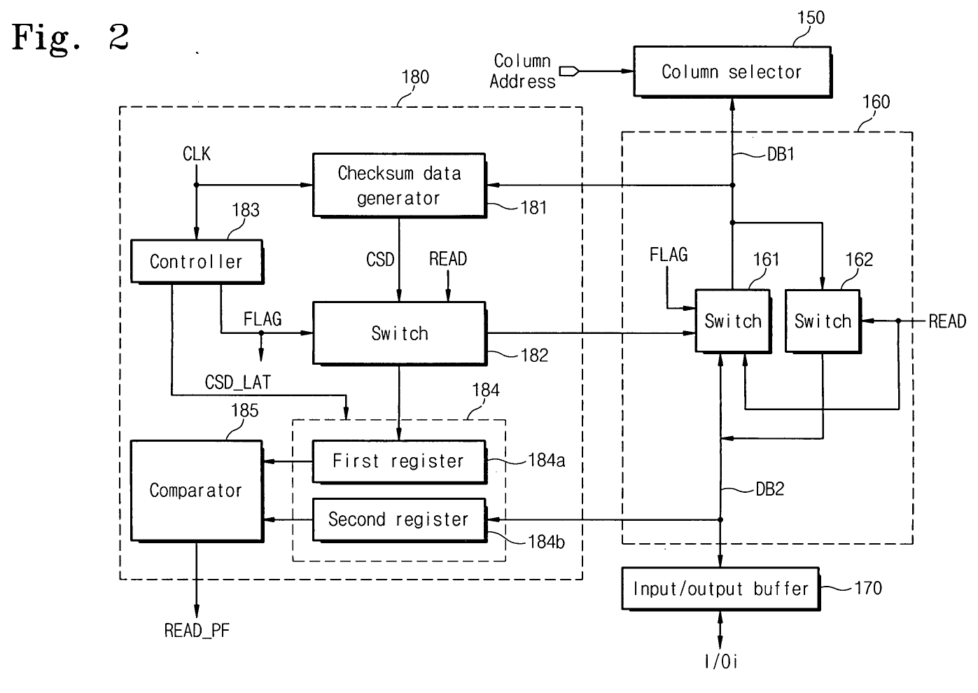

As illustrated by FIG. 2, the data path selection circuit 160 is responsive to (i) a read/write control signal READ generated by the control logic 130; and (ii) a flag signal FLAG generated by the power failure judging circuit 180. The read/write control signal READ may be set to a first logic level (e.g., logic 1) to signify a read operation and a second logic level (e.g., logic 0) to signify a write operation. This flag signal FLAG is generated by a controller 183 within the power failure judging circuit 180. As explained more fully hereinbelow, the flag signal FLAG may be switched to an active level to cause the generation of checksum data.

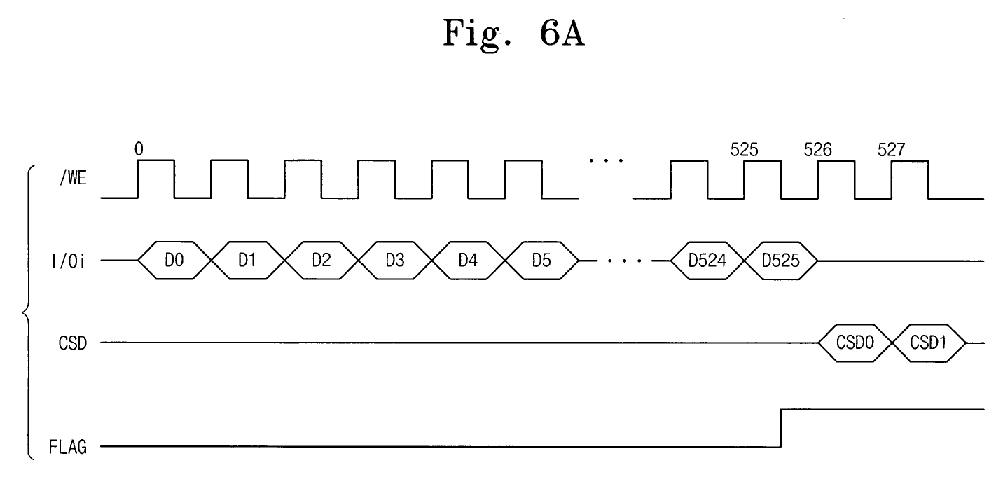

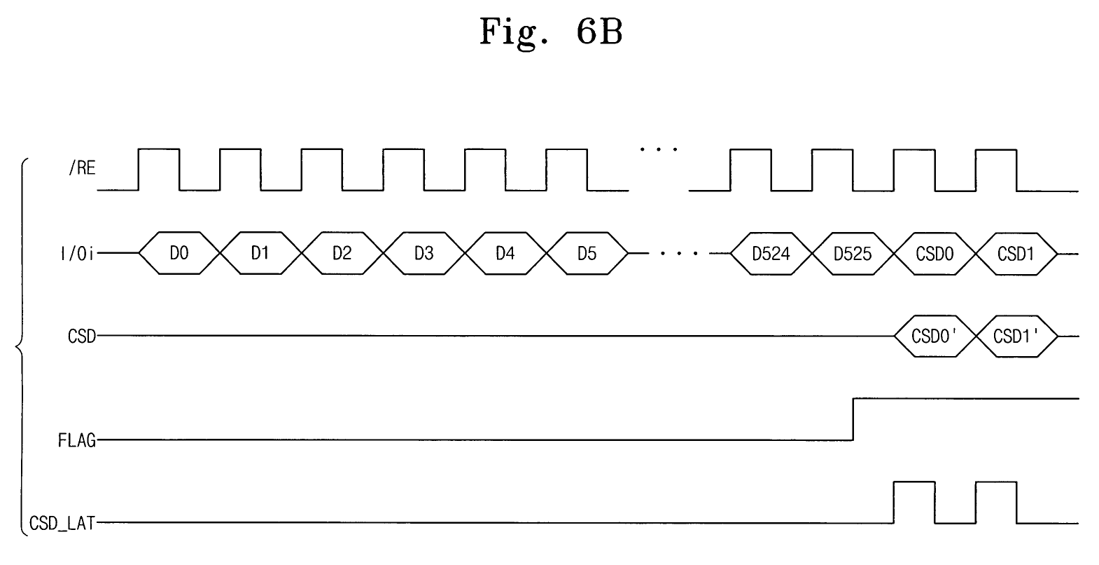

The data path selection circuit 160 is illustrated as including a first switch 161 and a second switch 162, which are responsive to the read/write control signal READ. The first switch 161 is enabled when the read/write control signal READ is set to a level that reflects a write operation and the second switch 162 is enabled when the read//write control signal READ is set to a level that reflects a read operation. When enabled during a write operation, the first switch 161 passes write data from the input/output buffer 170 to the column selector 150 via a first data bus DB1 and the second switch 162 is disabled. This first data bus DB1 is also coupled to an input of a checksum data generator 181. In contrast, during a read operation, the second switch 162 passes read data from the column selector 150 to the input/output buffer 170 via a second data bus DB2 and the first switch 161 is disabled. This second data bus DB2 is also coupled to an input of a second register 184b within a register set 184. Moreover, during a write operation, the first switch 161 may respond to an active flag signal FLAG by passing additional write data (e.g., checksum data) from a switch 182 within the power failure judging circuit 180 to the column selector 150 via the first data bus DB1. As explained more fully hereinbelow, this additional write data may be passed to the column selector 150 at a tail end of a write operation as illustrated by FIG. 6A (e.g., the last two cycles of a 528 cycle write operation). Moreover, the memory array 110, row selector 120, page register and sense amplifier circuit 140 and column selector 150 may be embodied within a first integrated circuit chip and the control logic 130, power failure judging circuit 180 and data path selector 160 may be embodied in within the same first integrated circuit chip or another second integrated circuit chip. The control logic 130, power failure judging circuit 180 and data path selector 160 may also be treated collectively as an input/output control circuit that performs checksum generation and power failure detection operations described hereinbelow.

The power failure judging circuit 180 of FIG. 2 is configured to detect an occurrence of a power failure during an operation to write data into the memory array 110. This detection, if any, occurs when defective write data (and possibly defective checksum data) is read from the memory array 110 and checked for errors by the power failure judging circuit 180. During a write operation, the checksum data generator 181 sequentially processes each byte of the incoming write data provided on the first data bus DB1. As described more fully hereinbelow with respect to FIG. 6A, the checksum data generator 181 may sequentially process 526 bytes (8-bits/byte) of write data during each operation to write a page of data into the memory array 110. In response to this sequential processing, the checksum data generator 181 generates a calculated checksum data value (CSD), which is provided to a switch 182. This switch 182 is responsive to the flag signal FLAG generated by the controller 183 and the read/write control signal READ. When the read/write control signal READ is set to reflect a write operation, the switch 182 routes the calculated checksum data (CSD) from the checksum generator 181 to an input of the switch 161 upon receipt of an active flag signal FLAG. The switch 161 then routes this checksum data (CSD) to the column selector 150 via the first data bus DB1. Alternatively, when the read/write control signal READ is set to reflect a read operation, the switch 182 routes the newly calculated checksum data (CSD) to a first register 184a within the register set 184. During a read operation, the second register 184b will also be loaded with checksum data provided by the second data bus DB2. This checksum data from the second data bus DB2 is received from the column selector 150 during an operation to read a page of data from the memory array 110. These first and second registers 184a and 184b are synchronized with a leading edge(s) of a latching signal CSD_LAT, which is generated by the controller 183 after a predetermined number of cycles of the clock signal CLK have been received by the controller 183.

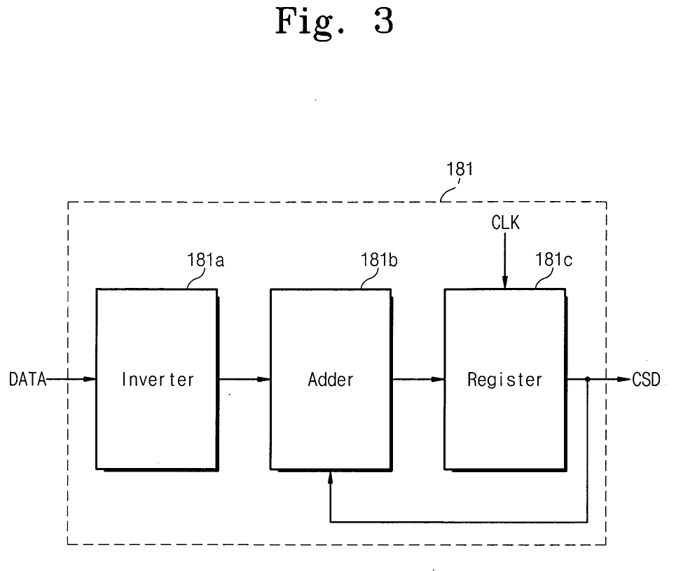

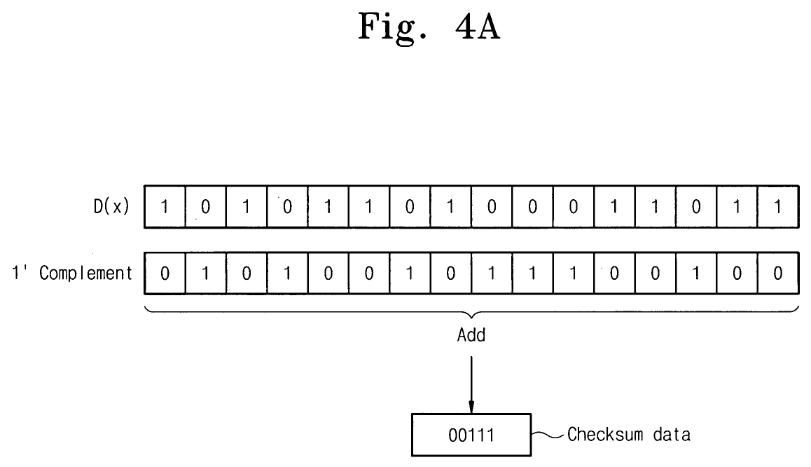

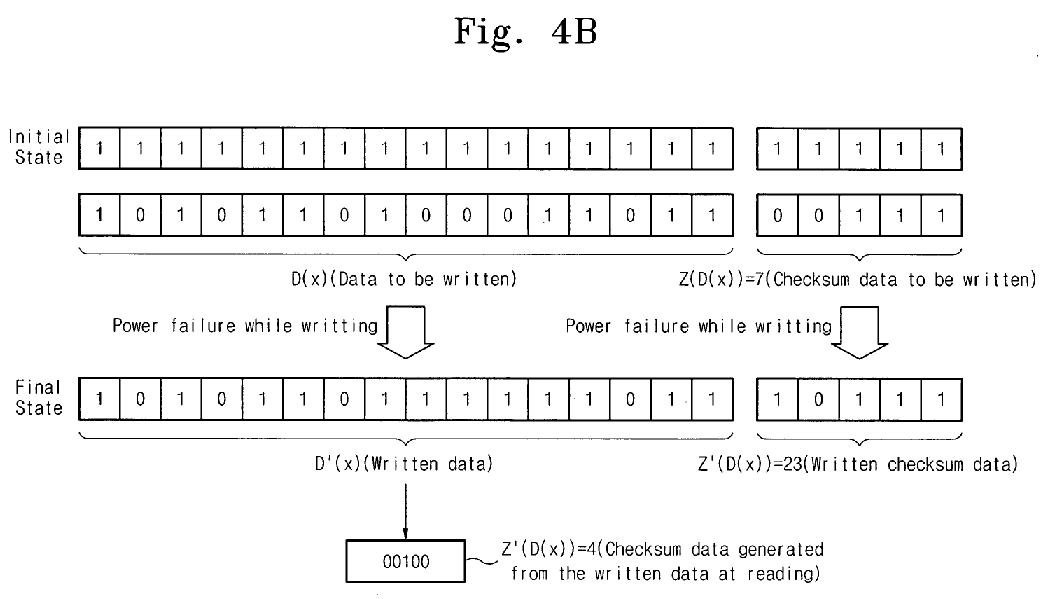

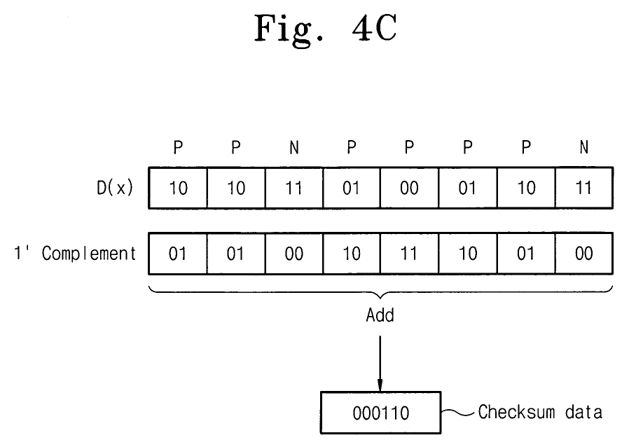

As illustrated by FIGS. 3 and 4A, the checksum generator 181 may be configured to generate a checksum data value CSD from a sequential stream of data bytes (e.g., 526 8-bit data bytes) provided by the first data bus DB1 during write and read operations. During write operations, the generated checksum data value CSD (e.g., 2-byte value) is routed to the first data bus DB1 via the switches 182 and 161, however, during read operations, the generated checksum data value CSD is routed to the first register 184a within the register set 184 in order to support error detection operations (e.g., detect one or more errors caused by a power failure event occurring during a prior write operation). The checksum generator 181 includes an inverter circuit 181a, an adder 181b and an accumulation register 181c that is responsive to the clock signal CLK generated by the control logic 130. The register 181c generates a checksum value that is fed back to the adder 181b so that intermediate checksum data values can be added to incoming checksum data updates generated from each data byte received from the first databus DB1.

As illustrated by FIG. 4A, a checksum data value may be generated by computing a 1's complement of a data value (shown as D(x)). This can be achieved by inverting each individual bit within the data value D(x) using the inverter 181a. The number of logic 1 values within the inverted data value are then summed together using the adder 181b. In the illustrated example of FIG. 4A, the 1's complement of a 16-bit data value D(x) contains seven (7) logic 1 values, which means the checksum data value (CSD) may be represented in binary format as: 00111. As will be understood by those skilled in the art, the length of a binary CSD value is equivalent to log₂N+1, where N equals a number of bits in the data value D(x) from which the CSD value is computed. Thus, for N=16, the length of the binary CSD value equals five (log₂ 16+1=5). The value of N need not necessarily correspond to the number of memory cells in a page that are programmed during a write operation. For example, FIG. 4C illustrates how a checksum data value may be determined when the nonvolatile memory cells within a memory array support 2-bits of programming data per cell (i.e., each cell has one unprogrammed state and three programmable states). In this case, eight memory cells may generate 16-bits of data D(x). A 1's complement of the 16-bits is determined and then a summing operation is performed to identify a number of logic 1 values within the complement of the data D(x). As illustrated, this number is equivalent to 6 in binary format (i.e., CSD=000110). This number represents checksum data that can be stored within three cells that support 2-bits per cell.

FIG. 4B illustrates an initial unprogrammed state of 21 adjacent memory cells within a nonvolatile memory array (e.g., flash memory array). These unprogrammed states are reflected as logic 1 values. Sixteen of these memory cells are configured to support actual data received by a memory device during a write operation and five of these memory cells are configured to support a checksum data value, which identifies how many of the sixteen memory cells that are to be programmed during a write operation. The 16-bit data value D(x) to be written is illustrated as including seven logic 0 values, which means that seven of the sixteen memory cells receiving actual data are to be programmed during a write operation. By determining a 1's complement of the data value D(x) and summing all the logic 1 values together, a checksum data value of seven is generated. This checksum data value Z(D(x)) is reflected in binary format as: 00111. FIG. 4B also illustrates how the occurrence of a power failure during a write operation (e.g., programming operation) results in a fewer number of logic 0 values being written into the 16 memory cells holding actual data and the memory cells holding the checksum data value. This power failure can be detected by evaluating a final state of the memory cells after programming (i.e., after a page write operation has been performed). As illustrated by FIG. 4B, the final state of the memory cells reflects multiple errors, with D′(x) representing the actual written data (with errors) and Z′(D(x)) representing the programmed checksum data value (with errors). The bottom of FIG. 4B also illustrates a checksum data value that is generated from D′(x), the erroneously written data, during a read operation. This checksum data value is shown as 00100, which is less than the original correct value of 00111 and less than the erroneous value of Z′(D(x)), which equals 10111 (i.e., 23 in binary format).

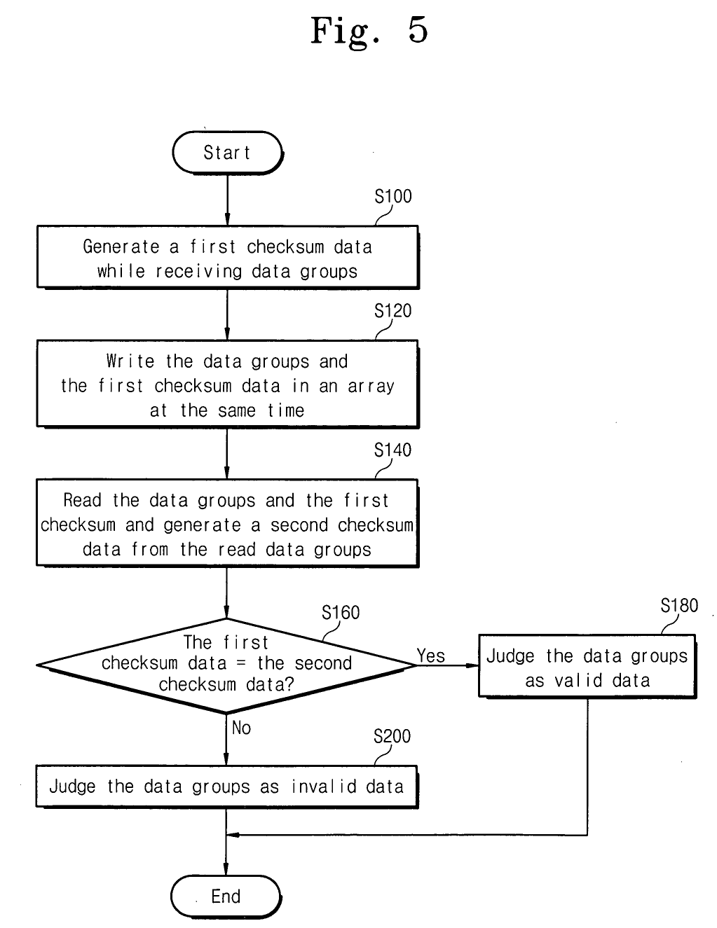

Thus, as illustrated by FIG. 5, reading erroneous data from the memory array 110 and then comparing a checksum data value (i.e., Z(D′(x))) computed from the erroneous data value (i.e., D′(x)) against a correct (or erroneous) checksum value (e.g., Z′(D(x)) read directly from the memory array 110 can yield an assessment that a power failure occurred during a prior operation to write a page of data into the memory array 110. In particular, Block S100 in FIG. 5 illustrates operations to generate first checksum data from a page of write data. The first checksum data, shown as CSD in FIG. 2, is then routed through the switches 182 and 161 to the data bus DB1 and the column selector 150. The page of write data and the first checksum data are then sequentially transferred to the page register and sense amplifier circuit 140 and then written in parallel into the memory array 110, Block S120. Thereafter, during the read operation illustrated by Block S140, the prior page of write data and the first checksum data are passed in sequence through the second switch 162 to the data bus DB2. This page of write data is then passed to the input/output buffer 170 and the first checksum data read from memory is passed to the second register 184b. Also during these read operations, second checksum data is computed by the checksum data generator 181 and passed through the switch 182 to the first register 184a. This second checksum data is generated from the page of data passing from the column selector 150 to the second switch 162.

Referring now to Block S160, a comparison operation is performed between the first checksum data within the second register 184b and the second checksum data within the first register 184a. This comparison operation is performed by the comparator 185 illustrated by FIG. 2. If the first checksum data and the second checksum data are equivalent, Block S180, then the data read from the memory array 110 is considered valid and the comparator generates a signal (READ_PF) at an inactive level, which designates no power failure error. However, if the first checksum data and the second checksum data are not equivalent, Block S200, then the data read from the memory array 110 is considered invalid and the comparator generates a signal (READ_PF) at an active level, which designates the occurrence of at least one power failure error within the data passed to the input/output buffer 170. The signal READ_PF may be recorded within the status register 131 within the control logic 131 and result in the generation of signal R/nB, which designates an error/no-error condition in the read data provided to an output port I/Oi.

As illustrated by FIG. 6A, the clock signal CLK generated by the control logic 130 of FIG. 1 may be used to generate a periodic write enable signal /WE. This write enable signal /WE synchronizes the serial transfer of 8-bit data from the input/output port I/Oi to the column selector 150. This transfer is illustrated as spanning 528 cycles of the write enable signal /WE. The first 526 of the 528 cycles are dedicated to writing 8-bit data bytes through the column selector 150 and into the page register and sense amplifier 140. The receipt of the 526^{th} cycle of /WE also triggers the generation of an active flag signal FLAG. This active flag signal FLAG is received by the switch 182 within the power failure judging circuit 180 and the first switch 161 within the data path selector 160. In response, the checksum data value CSD generated by the checksum data generator 181 is passed to through column selector 150 and into the page register and sense amplifier circuit 140. This checksum data value CSD is illustrated as requiring two 8-bit bytes (i.e., CSD0 and CSD1). This two byte requirement is necessary because the length of the checksum data value CSD is 13 bits (e.g., log₂(526 bytes×8 bits/byte)+1=13).

Similar timing requirements to those described above with respect to FIG. 6A are also required during a read operation, which is synchronized with a read enable signal /RE. The timing of a read operation is illustrated by FIG. 6B. In this timing, the generation of an active high flag signal FLAG results in the passing of first checksum data from the page register and sense amplifier 140 to the second register 184b within the register set 184 and the passing of second checksum data from the switch 182 to the first register 184a in the register set 184. The generation of the active high flag signal FLAG also results in the generation of two cycles of the latch signal CSD_LAT, which enables two 8-bit bytes of checksum data ((CSD0, CSD1) and (CSD0′, CSD1′)) to be loaded into each of the registers within the register set 184.

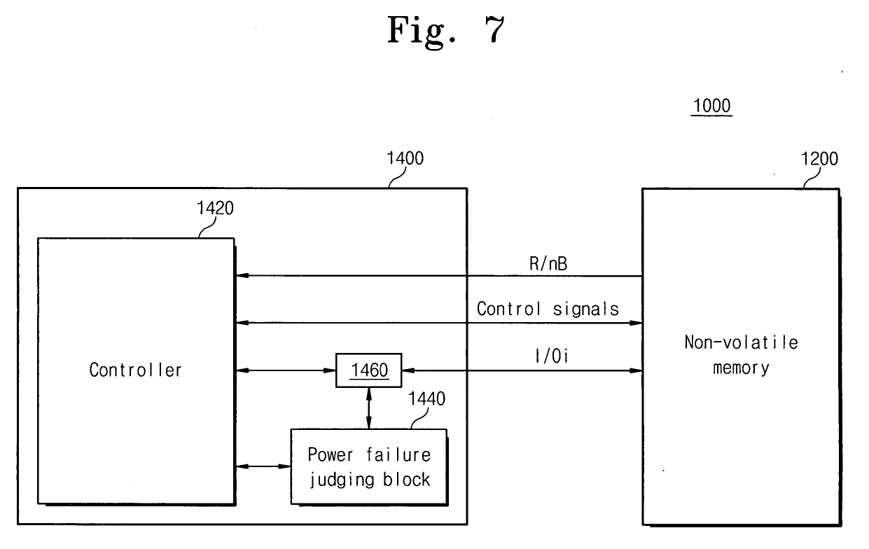

Integrated circuit memory devices according to additional embodiments of the present invention utilize separate memory and controller circuitry. As illustrated by FIG. 7, an integrated circuit memory device 1000 includes a non-volatile memory device 1200 and a memory controller 1400, which may be configured as separate integrated circuit chips. In some embodiments of the invention, the non-volatile memory device 1200 may be a generic off-the-shelf flash memory device or other type of nonvolatile memory device. This memory device 1200 is illustrated as being responsive to a plurality of data and control signals, which are shown as R/nB, control signals and I/Oi. The memory controller 1400 includes a control logic circuit 1420, a data path selection unit 1460 and a power failure judging circuit 1440. The control logic circuit 1420, data path selection unit 1460 and power failure judging circuit 1440 may be equivalent to the control logic circuit 130, the power failure judging circuit 180 and the data path selection circuit 160 of FIGS. 1-2, and need not be described further herein. These circuits may collectively represent another type of input/output control circuit.

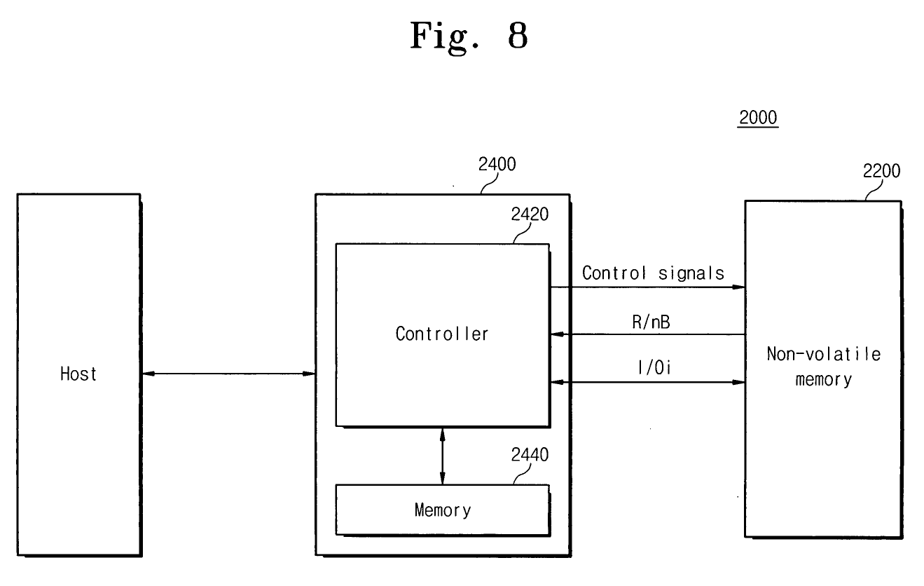

FIG. 8 illustrates an integrated circuit memory device 2000 according to another embodiment of the present invention. This memory device 2000 is illustrated as including a non-volatile memory device 1200 and a memory controller 2400, which may be configured as separate integrated circuit chips that are electrically coupled together and may even be packaged together. The memory controller 2400 includes a control logic circuit 2420 and a supplemental memory device 2440. The memory controller 2400 is responsive to signals generated by a command host (HOST). The control logic circuit 2420 is configured to perform many of the functions performed by the control logic circuit 1420, data path selection unit 1460 and power failure judging circuit 1440 of FIG. 7, however, the supplemental memory device 2440 is used to store a copy of the original checksum data to be stored within the non-volatile memory device 1200 during a write operation. In particular, during a write operation, the checksum data generated within the control logic circuit 2420 is provided to the non-volatile memory device 1200 and also to the supplemental memory device 2440. Thereafter, during a read operation, the checksum data read from the non-volatile memory device 1200 is compared to the corresponding checksum data read from the supplemental memory device 2440. This comparison operation is performed to determine the whether a power failure event occurred when the checksum data was originally written to the non-volatile memory 1200. The use of the supplemental memory device 2440 eliminates the need to independently calculate checksum data during a read operation and thereby reduces the read latency of a read operation relative to the device 100 of FIG. 1 and the device 1000 of FIG. 7.

In the drawings and specification, there have been disclosed typical preferred embodiments of the invention and, although specific terms are employed, they are used in a generic and descriptive sense only and not for purposes of limitation, the scope of the invention being set forth in the following claims. Moreover, all claim recitations describing a number of memory cells that are to be programmed during an operation or a number of memory cells that are programmed should also be treated as covering equivalent cases where the “number” actually represents unprogrammed memory cells and the number of programmed memory cells can be readily derived by subtracting a number of unprogrammed cells from a total number of cells.

That which is claimed is:

1. An integrated circuit device, comprising:
a memory device having a memory array therein containing a plurality of pages of memory cells; and
an input/output control circuit electrically coupled to said memory device, said input/output control circuit configured to support a page write operation by sequentially writing a plurality of segments of page data to said memory device in response to a write instruction, said plurality of segments including at least one segment of data that identifies a number of the memory cells to be programmed with write data during the page write operation.

2. The device of claim 1, wherein said input/output control circuit is further configured to support a page read operation by comparing the at least one segment of data against additional data that identifies a number of memory cells actually programmed with write data during the page write operation.

3. The device of claim 1, wherein the at least one segment of data comprises multiple segments of checksum data.

4. The device of claim 1, wherein said input/output control circuit comprises a checksum generator configured to generate the at least one segment of data.

5. The device of claim 2, wherein said input/output control circuit comprises a checksum generator configured to generate the at least one segment of data during the page write operation and further configured to generate the additional data during the page read operation.

6. The device of claim 1, wherein said input/output control circuit comprises a data path selection circuit disposed within a read/write data path of the integrated circuit device, said data path selection circuit comprising a first switch responsive to an active flag signal that enables checksum data to be passed to said memory device during page write operations.

7. The device of claim 6, wherein said input/output control circuit further comprises a checksum generator coupled to the read/write data path and a second switch configured to route checksum data from the checksum generator to the first switch in response to the active flag signal.

8. The device of claim 7, wherein said input/output control circuit further comprises a register set having a first register that is configured to receive checksum data from the second switch and a second register configured to receive checksum data from the read/write data path during a page read operation.

9. The device of claim 6, wherein said input/output control circuit is further configured to support a page read operation by comparing the at least one segment of data against additional data that identifies a number of memory cells actually programmed with write data during the page write operation.

10. The device of claim 7, wherein said input/output control circuit is further configured to support a page read operation by comparing the at least one segment of data against additional data that identifies a number of memory cells actually programmed with write data during the page write operation.

11. The device of claim 1, wherein said memory device and said input/output control circuit are disposed on a common semiconductor substrate.

12. An integrated circuit device, comprising:
a non-volatile memory device having a memory array therein containing a plurality of pages of memory cells; and
a memory controller electrically coupled to said non-volatile memory device, said memory controller configured to provide said non-volatile memory device with a plurality of segments of page data during a page write operation, said plurality of segments including a plurality of segments of checksum data that identify a number of non-volatile memory cells to be programmed with write data during the page write operation.

13. The device of claim 12, wherein said memory controller comprises a memory array configured to store a copy of the plurality of segments of checksum data transferred to the non-volatile memory device during the page write operation.

14. The device of claim 12, wherein memory controller is further configured to support a page read operation by comparing the plurality of segments of checksum data received from said non-volatile memory device during the page read operation against additional checksum data that identifies a number of memory cells in the memory array actually programmed with write data during the page write operation.

15. The device of claim 14, wherein said memory controller comprises a checksum data generator configured to generate the plurality of segments of checksum data during the page write operation and further configured to generate the additional checksum data during the page read operation.

16. The device of claim 14, wherein said non-volatile memory device and said memory controller are disposed on separate integrated circuit substrates.

17. A method of operating an integrated circuit memory device, comprising the steps of:
generating first checksum data from first data received by the memory device;
writing the first data and the first checksum data into a non-volatile memory array within the memory device; then
reading the first data and the first checksum data from the non-volatile memory array;
generating second checksum data from first data read from the non-volatile memory array; and
comparing the second checksum data against the first checksum data read from the non-volatile memory array to detect differences therebetween.

18. The method of claim 17, wherein said step of generating first checksum data comprises generating a plurality of segments of checksum data from a plurality of segments of the first data; and wherein said writing step comprises writing the plurality of segments of the first data and the plurality of segments of checksum data in sequence across a data bus.

19. The method of claim 18, wherein said step of generating first checksum data comprises generating intermediate checksum data values using an adder and accumulation register as the plurality of segments of the first data are processed in the memory device.

20. A method of operating an integrated circuit memory device, comprising the steps of:
generating first checksum data from first data received by the memory device;
writing the first data and the first checksum data into a non-volatile memory array within the memory device;
writing a copy of the first checksum data into another memory array within the memory device; then
reading the first data and the first checksum data from the non-volatile memory array; and
comparing the copy of the first checksum data read from the another memory array against the first checksum data read from the non-volatile memory array to detect differences therebetween.

21. The method of claim 20, wherein said step of generating first checksum data comprises generating a plurality of segments of checksum data from a plurality of segments of the first data; and wherein said writing step comprises writing the plurality of segments of the first data and the plurality of segments of checksum data in sequence across a data bus.
